(19) United States
(12) Patent Application Publication
(10) Pub. No.: US 2025/0086448 A1
(43) Pub. Date: Mar. 13, 2025

(54) GENERATIVE RECOMMENDATION MODEL LEVERAGING VERBALIZED SEQUENTIAL DATA

(71) Applicant: Adobe Inc., San Jose, CA (US)

(72) Inventors: Tanay ANAND, Noida (IN); Siddarth RAMESH, Noida (IN); Shripad Vilasrao DESHMUKH, Maharashtra (IN); Jayakumar SUBRAMANIAN, Noida (IN)

(21) Appl. No.: 18/367,020

(22) Filed: Sep. 12, 2023

(51) Int. Cl. G06N 3/08; G06N 3/0475

(52) U.S. Cl. CPC G06N 3/08; G06N 3/0475

(57) ABSTRACT

Systems and methods provide a generative recommendation model that leverages verbalizations generated from sequential data. In accordance with some aspects, sequential data for a trajectory comprising a plurality of steps is accessed, in which the sequential data comprises a tuple for each step of the trajectory. Verbalized sequential data is generated from the sequential data, in which the verbalized sequential data for each step of the trajectory comprises one or more natural language sentences generated from the tuple for the step. A generative model is trained on the verbalized sequential data to provide a trained generative model that generates a recommended action given a prompt specifying a current state.

### BACKGROUND

Recommendation is a fundamental problem that has gained utmost importance in the modern era in which vast amounts of information are often available. In the context of decision-making, recommendation systems have been designed to aid entities in making choices or selecting courses of action among various alternatives. Generally, the goal of such recommendation systems is to help identify an action to take given a number of possible actions. Conventional recommendation systems typically provide one-time recommendations based on predictions made from static information. Sequential recommendation systems, on the other hand, provide a sequence of recommendations based on where each recommendation would lead to a different path with a particular goal in mind.

### SUMMARY

Some aspects of the present technology relate to, among other things, a recommendation system that employs a generative model trained on verbalized sequential data to generate recommendations for decision-making processes. In accordance with some aspects, sequential data is accessed and converted to a verbalized format comprising natural language sentences to provide verbalized sequential data. The sequential data comprises data for one or more trajectories, where each trajectory includes an ordered sequence of steps. The data for a given step of trajectory is a tuple that can include data regarding a goal, state, action, and reward at that step. The verbalized sequential data for a step is generated by converting the tuple for the step into a verbalized form in which natural language sentences describe the data. A generative model is trained using the verbalized sequential data. In some instances, training the generative model comprises providing at least a state verbalization for the step as input to the generative model, which generates an output that is used in conjunction with at least the action verbalization for the step to update the generative model. Once trained, the generative model is used to generate recommended actions based on input prompts.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present technology is described in detail below with reference to the attached drawing figures, wherein:

FIG. 1 is a block diagram illustrating an exemplary system in accordance with some implementations of the present disclosure;

FIG. 2 provides an example of verbalized data generated from a step of sequential data in accordance with some implementations of the present disclosure;

FIGS. 3A and 3B provide an example of verbalized data generated from tabular data in accordance with some implementations of the present disclosure;

FIG. 4 provides an example of output generated by a generative model given a prompt in accordance with some implementations of the present disclosure;

FIG. 5 is a flow diagram showing a method for training a generative model using verbalized sequential data in accordance with some implementations of the present disclosure;

FIG. 6 is a flow diagram showing a method for generating verbalized sequential data for a step of a trajectory in accordance with some implementations of the present disclosure;

FIG. 7 is a flow diagram showing a method for training a generative model on verbalized sequential data for a step of a trajectory in accordance with some implementations of the present disclosure;

FIG. 8 is a flow diagram showing a method for employing a trained generative model to provide a recommendation in accordance with some implementations of the present disclosure;

FIG. 9 provides a chart comparing the performance of a generative model in accordance with some implementations of the present disclosure and the performance of a prior art reinforcement learning approach; and

FIG. 10 is a block diagram of an exemplary computing environment suitable for use in implementations of the present disclosure.

### DETAILED DESCRIPTION

### Definitions

Various terms are used throughout this description. Definitions of some terms are included below to provide a clearer understanding of the ideas disclosed herein.

As used herein, “sequential data” refers to data that it is ordered or otherwise structured in a sequence of events over a period of time. In accordance with aspects of the technology described herein, sequential data is collected from real-world scenarios or otherwise obtained, and the sequential data is used in training a generative model for recommendations. Sequential data can include one or more trajectories.

A “trajectory” includes a series of interconnected steps—i.e., one step leads to another interconnected step. At each “step”, an agent interacts with an environment in a given state by taking an action. In the context of reinforcement learning, the agent receives feedback at each step in the form of a reward based on the selected action.

A “tuple” sets forth the sequential data for a step of a trajectory. A tuple for a given step comprises information identifying a state at the step and an action taken at the step. In some configurations, the tuple for a step also includes a reward that was provided as feedback based on the selected action. In some configurations, the tuple for a step further includes a goal that reflects a cumulative reward remaining for a trajectory at that step.

“Tabular data” is used herein to refer to structured data that is organized into rows and columns, resembling a table, where each row represents a record or instance, and each column represents a specific attribute or feature. In some instances, sequential data is provided in the form of tabular data in which each row/record in the tabular data corresponds to a step of a trajectory.

“Verbalized sequential data” refers to sequential data that has been converted from its original format into one or more natural language sentences. A natural language sentence comprises a grammatically-structured sequence of words in a human-understandable format to communicate some information. In accordance with some aspects of the technology described herein, a tuple representing the data for a step of a trajectory is converted to natural language sentences. For instance, if a tuple includes data setting forth a goal, state, action, and reward, the verbalized structured data includes a goal verbalization, a state verbalization, an action verbalization, and a reward verbalization. The goal verbalization includes one or more natural language sentences generated from the goal data; the state verbalization includes one or more natural language sentences generated from the state data; the action verbalization includes one or more natural language sentences generated from the action data; and the reward verbalization includes one or more natural language sentences generated from the reward data. The verbalization of a step is referred to herein as a verbalized step.

A “generative model” is used herein in the context of natural language processing to refer to a type of machine learning model that generates new text. In accordance some aspects of the technology described herein, a generative model is trained on verbalized sequential data to provide a trained generative model that generates recommendations based on input prompts. In some configurations, the generative model comprises a large language model (LLM) that is designed to understand and generate human-like text. A LLM generally refers to a type of generative model that has been trained on massive amounts of text data to learn the patterns, relationships, and semantics of language. By way of example only and not limitation, some configurations can employ a pre-trained LLM, such as GPT-2, and fine-tuned the pre-trained LLM to provide a trained generative model.

### Overview

Recommendation systems have been developed to facilitate decision-making in a variety of different domains. In some cases, systems have attempted to leverage large language models (LLMs), such as ChatGPT and GPT-3, to aid in decision-making processes. However, these models are not grounded in data, leading to poor performance in real-world scenarios. LLMs often generate generic suggestions unsupported by firm-specific data and tend to hallucinate responses, resulting in error propagation throughout the decision-making process.

As an alternative, some recommendation systems have employed reinforcement learning (RL) based models. Reinforcement learning involves a learning agent learning from interactions with an environment. Reinforcement learning involves providing rewards (positive or negative) for recommended actions selected by the learning agent in particular states in order for the learning agent to learn an optimal policy that dictates what recommended actions should be selected given different system states. Unfortunately, RL-based models pose their own set of challenges due to their abstract nature, making them difficult to work with when compared to natural language interfaces. Presently, RL models require a sequence of state, action, and reward tuples derived from data, making it impossible to provide additional context around new developments or world events that should be considered in various decision-making processes.

Several existing solutions (e.g., Grounding LLMs, SayCan, and Decision Transformers) have been developed to address the challenges of grounding LLMs in real-world environments and using them for decision-making. However, these attempts have a number of shortcomings. For instance, one previous approach aims to align LLMs' knowledge with the environment by functionally grounding them through online reinforcement learning as the agent interacts with the environment. However, this approach depends on an action compiler, which is usually easy to implement for simple environments but is infeasible for real world decision-making.

Another prior approach focuses on combining pre-trained skills with LLMs to constrain a model to propose natural language actions that are both feasible and contextually appropriate in a robotic context. However, while this approach has been shown to work with constraints, it is unsuitable for use cases where it is difficult to put constraints on actions while also trying to generalize.

A further prior approach presents a framework called a decision transformer that abstracts RL as a sequence modeling problem, leveraging the simplicity and scalability of the transformer architecture. However, decision transformers are highly abstract and hence difficult to work with. They also are rigid, in that, adding extra context to states is infeasible.

Yet another prior approach builds on decision transformers by extending the large-scale language modelling approach to build a multi-modal, multi-task, multi-embodiment generalist policy capable of various tasks. However, the decision-making aspect of this approach is still constrained by abstract RL input and hence suffers from similar issues as the decision transformer.

Aspects of the technology described herein improve the functioning of the computer itself by providing a recommendation system that addresses the limitations of both LLMs and RL models for decision-making by combining their strengths. Some aspects of the technology described herein utilize the world knowledge stored in LLMs while harnessing the power of RL algorithms. This approach allows for goals to be specified and extra contextual information in natural language to be provided, enhancing the overall decision-making process. At a high level, in some configurations, environmental dynamics are provided in the space of natural language by converting traditional sequential data (which can include state, action, and/or reward data) into a verbalized format. This verbalized data is then used to fine-tune a generative model to generate recommendations for decision-making. The trained generative model generates decision-making suggestions in both natural language and abstract data formats, such as JSON, offering a more grounded and data-driven approach to decision support.

In accordance with some aspects of the technology described herein, sequential data is accessed. The sequential data includes data for one or more trajectories. Each trajectory includes an ordered sequence of steps. In some instances, the sequential data includes tabular data in which each row/record in the tabular data corresponds to a step in a trajectory. The sequential data for each step comprises a tuple. In some instances, the tuple for a step includes goal data for a goal at that step, state data for a state at that step, action data for an action taken at that step, and reward data for a reward provided at that step. In some aspects, the sequential data comprises data collected from one or more previous decision-making processes.

The sequential data is converted from its original form to a verbalized form to provide verbalized sequential data. This can include mapping features and/or values from the sequential data to natural language sentences. In some configurations, continuous values in the sequential data are converted to discrete values that are better handled by some types of generative models (e.g., transformer-based models). When the tuple for a step comprises goal, state, action, and reward data, the verbalized sequential data for the step comprises: a goal verbalization that includes one or more natural language sentences describing the goal data for the step; a state verbalization that includes one or more natural language sentences describing the state data for the step; an action verbalization that includes one or more natural language sentences describing the action data for the step; and a reward verbalization that includes one or more natural language sentences describing the reward data for the step. Each of the verbalizations can include introductory and/or concluding sentences to delineate the verbalizations. For instance, the state verbalization could include the introductory sentence—“State starts”—and the concluding sentence—“State ends.”

A generative model is trained on the verbalized sequential data. The generative model can be iteratively trained over verbalized data for steps from a trajectory. For a given step, training the generative model can include providing an input comprising at least the state verbalization (and in some instances, the goal verbalization) for the step. Given that input, the generative model generates an output (e.g., a predicted action), and the output is used in conjunction with at least the action verbalization (and in some instances, the reward verbalization) for the step to update the generative model (e.g., via backpropagation). Once trained, the generative model can be employed to generate recommendations given input prompts to facilitate decision-making processes.

Aspects of the technology described herein provide a number of improvements over existing recommendation systems. For instance, some aspects leverage the world knowledge implicitly stored in LLMs and the powerful modelling capabilities of RL for sequential decision making. This approach effectively facilitates comprehending and utilizing RL recommendations by providing a way to verbalize RL journeys, bridging the gap between powerful models and practical decision-making. The technology described herein is also able to generate suggestions in multiple formats (in some aspects, grounded in real-world datasets), which provides an improvement over prior decision-making tools. Using a recommendation system based on aspects of the technology described herein facilitate entities in easily comprehending and employing generated recommendations, leading to data-driven decision-making and more efficient strategies. Furthermore, aspects of the technology described herein provide the ability to query the framework separately for insights on the recommendations, thereby providing transparency and clarity. This further assists in better understanding the reasoning behind the generated recommendations, allowing for informed decisions, thereby improving governance and accountability in decision-making processes. As another improvement over previous approaches, once the generative model has been trained on a particular environment (or a small subset of environments), the generative model can be generalized and used in other related environments. For instance, if a generative model is trained on marketing data, the generative model can be deployed in a sales environment.

### Example Generative Recommendation System Leveraging Verbalized Sequential Data

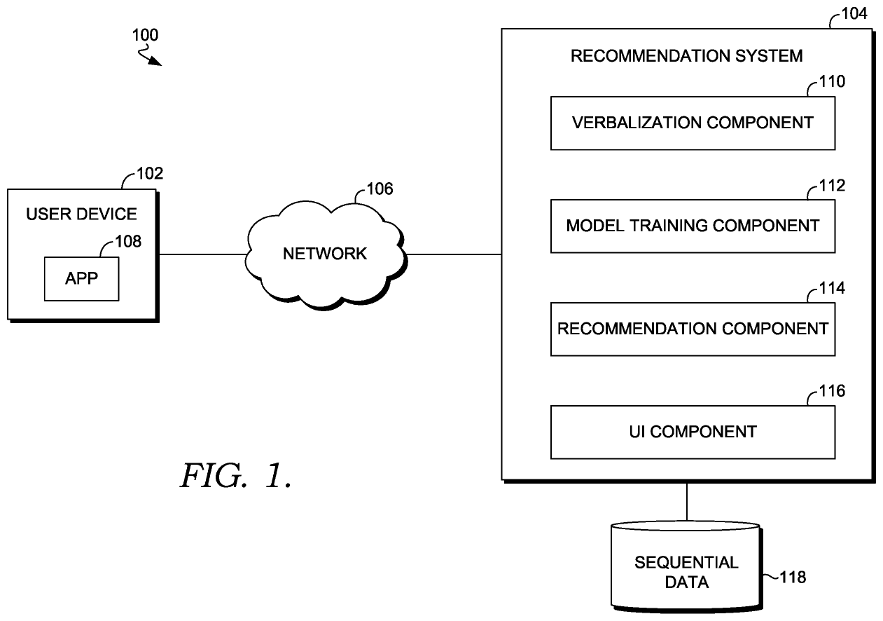

With reference now to the drawings, FIG. 1 is a block diagram illustrating an exemplary system 100 for providing recommendations using a generative model trained on verbalized sequential data in accordance with implementations of the present disclosure. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, various functions can be carried out by a processor executing instructions stored in memory.

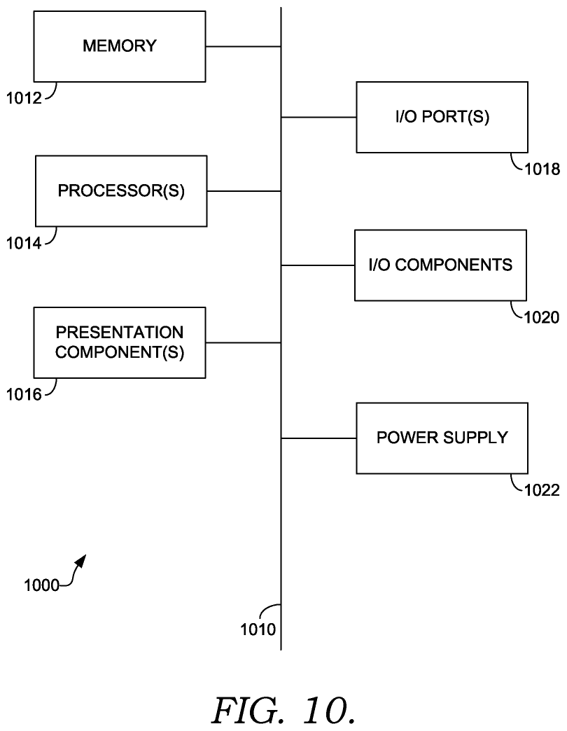

The system 100 is an example of a suitable architecture for implementing certain aspects of the present disclosure. Among other components not shown, the system 100 includes a user device 102 and an recommendation system 104. Each of the user device 102 and recommendation system 104 shown in FIG. 1 can comprise one or more computer devices, such as the computing device 1000 of FIG. 10, discussed below. As shown in FIG. 1, the user device 102 and the recommendation system 104 can communicate via a network 106, which can include, without limitation, one or more local area networks (LANs) and/or wide area networks (WANs). Such networking environments are commonplace in offices, enterprise-wide computer networks, intranets, and the Internet. It should be understood that any number of user devices and server devices can be employed within the system 100 within the scope of the present technology. Each can comprise a single device or multiple devices cooperating in a distributed environment. For instance, the recommendation system 104 could be provided by multiple server devices collectively providing the functionality of the recommendation system 104 as described herein. Additionally, other components not shown can also be included within the network environment.

The user device 102 can be a client device on the client-side of operating environment 100, while the recommendation system 104 can be on the server-side of operating environment 100. The recommendation system 104 can comprise server-side software designed to work in conjunction with client-side software on the user device 102 so as to implement any combination of the features and functionalities discussed in the present disclosure. For instance, the user device 102 can include an application 108 for interacting with the recommendation system 104. The application 108 can be, for instance, a web browser or a dedicated application for providing functions, such as those described herein. This division of operating environment 100 is provided to illustrate one example of a suitable environment, and there is no requirement for each implementation that any combination of the user device 102 and the recommendation system 104 remain as separate entities. While the operating environment 100 illustrates a configuration in a networked environment with a separate user device 102 and recommendation system 104, it should be understood that other configurations can be employed in which components are combined. For instance, in some configurations, the user device 102 can provide some or all of the capabilities of the recommendation system 104 described herein.

The user device 102 comprises any type of computing device capable of use by a user. For example, in one aspect, the user device comprises the type of computing device 1000 described in relation to FIG. 10 herein. By way of example and not limitation, the user device 102 can be embodied as a personal computer (PC), a laptop computer, a mobile or mobile device, a smartphone, a tablet computer, a smart watch, a wearable computer, a personal digital assistant (PDA), an MP3 player, global positioning system (GPS) or device, video player, handheld communications device, gaming device or system, entertainment system, vehicle computer system, embedded system controller, remote control, appliance, consumer electronic device, a workstation, or any combination of these delineated devices, or any other suitable device where notifications can be presented. A user can be associated with the user device 102 and can interact with the recommendation system 104 via the user device 102.

As will be described in further detail below, the recommendation system 104 takes sequential data (e.g., from the data store 118) and generates verbalized descriptions of the sequential data. The recommendation system 104 uses the verbalized sequential data to train a generative model (e.g., an LLM) to generate recommendations. As shown in FIG. 1, the recommendation system 104 includes a verbalization component 110, a model training component 112, a recommendation component 114, and a user interface (UI) component 116. The components of the recommendation system 104 can be in addition to other components that provide further additional functions beyond the features described herein. The recommendation system 104 can be implemented using one or more server devices, one or more platforms with corresponding application programming interfaces, cloud infrastructure, and the like. While the recommendation system 104 is shown separate from the user device 102 in the configuration of FIG. 1, it should be understood that in other configurations, some or all of the functions of the recommendation system 104 can be provided on the user device 102.

In one aspect, the functions performed by components of the recommendation system 104 are associated with one or more applications, services, or routines. In particular, such applications, services, or routines can operate on one or more user devices, servers, can be distributed across one or more user devices and servers, or be implemented in the cloud. Moreover, in some aspects, these components of the recommendation system 104 can be distributed across a network, including one or more servers and client devices, in the cloud, and/or can reside on a user device. Moreover, these components, functions performed by these components, or services carried out by these components can be implemented at appropriate abstraction layer(s) such as the operating system layer, application layer, hardware layer, etc., of the computing system(s). Alternatively, or in addition, the functionality of these components and/or the aspects of the technology described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some aspects, functionality of these components can be shared or distributed across other components.

The verbalization component 110 of the recommendation system 104 takes sequential data (e.g., from the data store 118) and generates verbalizations comprising natural language sentences to provide verbalized sequential data. As shown in FIG. 1, a data store 118 provides a source of sequential data. The sequential data comprises information regarding an ordered sequence of agent interactions with an environment. In some aspects, the sequential data is obtained from real-world scenarios. For instance, in the context of marketing, the sequential data can comprise information that was collected from real-world marketing scenarios (e.g., observations at various stages of a marketing campaign and marketing actions taken at each stage). As another example, in a medical context, the sequential data can comprise information that was collected from real-word medical treatment scenarios (e.g., patient demographics, patient conditions, and treatment actions taken).

In some instances, the sequential data comprises a number of trajectories. Each trajectory includes a chronologically-ordered sequence of steps. At each step, an agent action was taken given a particular state of the environment. The sequential data for a given step of a trajectory can comprise a tuple. The tuple includes data describing a state at a given step and an action taken at the step. In some configurations, the tuple also includes a reward that was provided for the step based on the action. The tuple can further include a goal that reflects a cumulative reward remaining in the trajectory at the step.

The sequential data can be provided in any of a variety of different formats. In some instances, the sequential data comprises tabular data that is organized into rows and columns. Each column corresponds with a given feature, and each row corresponds with a record that sets forth values (i.e., feature values) for the features. The tabular data can comprise a trajectory with each row/record in the tabular data corresponding to a step of the trajectory.

The verbalization component 110 converts the sequential data from its original format into one or more natural language sentences to generate verbalized sequential data. In accordance with some aspects of the technology described herein, the verbalization component 110 uses one or more templates to map data from the sequential data into a verbalized form. For instance, a given template could include one or more natural language sentences that include placeholders into which different data from the sequential data is inserted to generate the verbalizations. In further configurations, the verbalization component 110 comprises a language model that is trained to understand the sequential data and generate the verbalizations.

For a given step of a trajectory, the verbalization component 110 maps various portions of the data for the step to verbalized form. For instance, if the data for step comprises a tuple that includes data regarding a goal, state, action, and reward for the step, the verbalization component 101 employs: the goal data to generate a natural language description of the goal (i.e., a “goal verbalization”); the state data to generate a natural language description of the state (i.e., a “state verbalization”); the action data to generate a natural language description of the action (i.e., a “action verbalization”); and the reward data to generate a natural language description of the reward (i.e., a “reward verbalization”). Collectively, the verbalized data for a given step is referred to herein as a verbalized step.

In some instances, the verbalization component 110 generates each verbalization of a verbalized step to include introductory and concluding sentences to delineate the different portions of the verbalized structured data for the step. For instance, a state verbalization for a verbalized step could include the introductory sentence, “State starts”, and the concluding sentence, “State ends”; while an action verbalization for the verbalized step could include the introductory sentence, “Action start”, and the concluding sentence, Action ends.” In between the introductory and concluding sentence for each verbalization are one or more data natural language sentences providing a verbalized form of the relevant data. For instance, the state verbalization includes one or more natural language sentences with state data in between the “State starts” and “State ends” sentences. Use of such introductory and concluding sentences can assist when training the generative model to help the generative model understand where each portion of the verbalized sequential data starts and ends.

In some configurations, the goal included with each step of a trajectory is a return_to_go, which is the cumulative reward remaining in a trajectory at each step. In such configurations, the return_to_go is prepended to each step in the trajectory and acts as the desired goal. For any state s, in the trajectory, return_to_go is defined as:

$$R T {G}_{t} = {\sum }_{j = t}^{T} {r}_{j} \qquad ( 1 )$$

where T is the length of the trajectory and rⱼ is the per step reward at step j. By way of a simple example, suppose a trajectory includes five steps and the rewards for the steps are as follows: step 1=1; step 2=0; step 3=2; step 4=2, and step 5=2. In this example, the return_to_go for the steps would be as follows: step 1=7; step 2=6; step 3=6; step 4=4; and step 5=2.

Some LLMs (e.g., transformer-based models) are not good a handling continuous values (e.g., observations values and reward values). To address this issue, in some configurations, the verbalization component 110 converts continuous values to discrete values when generating verbalizations. The process can include normalizing the continuous values and placing them in bins. For instance, in some aspects, the continuous values are mu_law encoded to the range [−1, 1] (if not already there) and then discretized to uniform bins (e.g., 512 bins). In some instances, the mu_law is defined as:

$$F ( x ) = sgn ( x ) \frac{log ( \vert x \vert μ + 1. )}{log ( M μ + 1.0 )} \qquad ( 2 )$$

where, in some configurations: μ=511 and M=512.

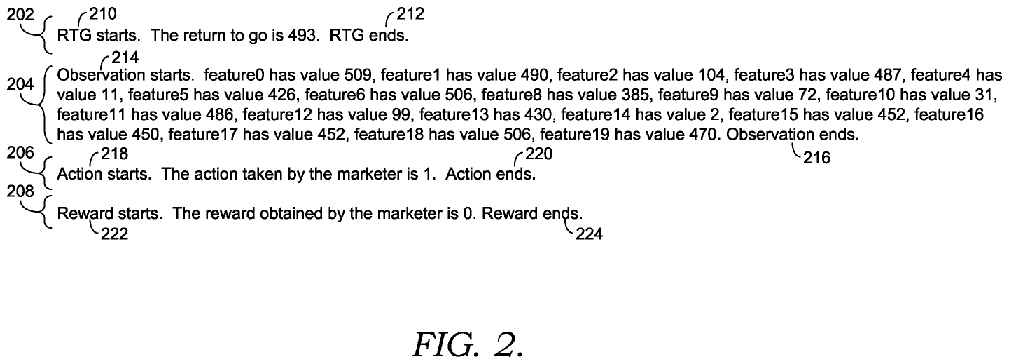

By way of example to illustrate generation of verbalized sequential data, FIG. 2 provides an example of a verbalized step 200 generated for a step of a trajectory in sequential data. In particular, the verbalized step 200 comprises natural language text generated based on data from a step of a trajectory in the sequential data. In the example of FIG. 2, the data from the step used to generate the verbalized step 200 includes goal data, state data, action data, and reward data. The goal data comprises information regarding an end goal for the trajectory at that given step. The state data comprises information regarding a current state at the given step. The action data comprises information regarding at action taken at the given step. The reward data comprises information regarding a reward provided based on the action taken at the given step.

As shown in FIG. 2, the verbalized step 200 includes a goal verbalization 202, a state verbalization 204, an action verbalization 206, and a reward verbalization 208. The goal verbalization 202 comprises natural language sentences generated from the goal data for the step. The state verbalization 204 comprises natural language sentences generated from the state data for the step. The action verbalization 206 comprises natural language sentences generated from the action data for the step. The reward verbalization 208 comprises natural language sentences generated from the reward data for the step.

Each of the goal verbalization 202, state verbalization 204, action verbalization 206, and reward verbalization 208 comprise introductory and concluding sentences to help identify the beginning and end of each portion of the verbalized step 200. In particular, the goal verbalization 202 includes introductory sentence 210 (“RTG starts.”) and concluding sentence 212 (“RTG ends.”). The state verbalization 204 includes introductory sentence 214 (“Observation starts.”) and concluding sentence 216 (“Observation ends.”). The action verbalization 206 includes introductory sentence 218 (“Action starts.”) and concluding sentence 220 (“Action ends.”). The reward verbalization 208 includes introductory sentence 222 (“Reward starts.”) and concluding sentence 224 (“Reward ends.”).

In between the introductory and concluding sentences for each of the goal verbalization 202, state verbalization 204, action verbalization 206, and reward verbalization 208 are natural language sentences generated from the specific data for the step. In particular, the goal verbalization 202 includes a natural language sentence that specifies the return to go is 493. The state verbalization 204 includes a natural language sentence that sets forth values for a number of features describing the state at the step. In the example of FIG. 2, each feature in the sentence could correspond to a feature of the state data, and each feature value could correspond to a particular numerical or text value. For instance, in the context of medical treatment, a particular feature could correspond to a patient demographic (e.g., gender), and the value included in the sentence could correspond to a value for that feature (e.g., 0=male; and 2=female). The action verbalization 206 includes a natural sentence regarding the action taken at the step. In this example, the sentence indicates that “The action taken by the marketer is 1.” The 1 value in the sentence could correspond to a particular action, such as sending a particular type of email. The reward verbalization 208 includes a natural language sentence regarding the reward provided at the step.

Although FIG. 2 provides an example of verbalized data generated for a single step of a trajectory, in operation, verbalized data (similar to the verbalized step 200) would be generated for each step of the trajectory. As such, the verbalized data for the trajectory would include an ordered sequence of verbalized steps (similar to the verbalized step 200) corresponding to the goal, state, action, and reward data from the ordered sequence of steps for the trajectory. Verbalized data could similarly be generated for each trajectory in the sequential data available to the system.

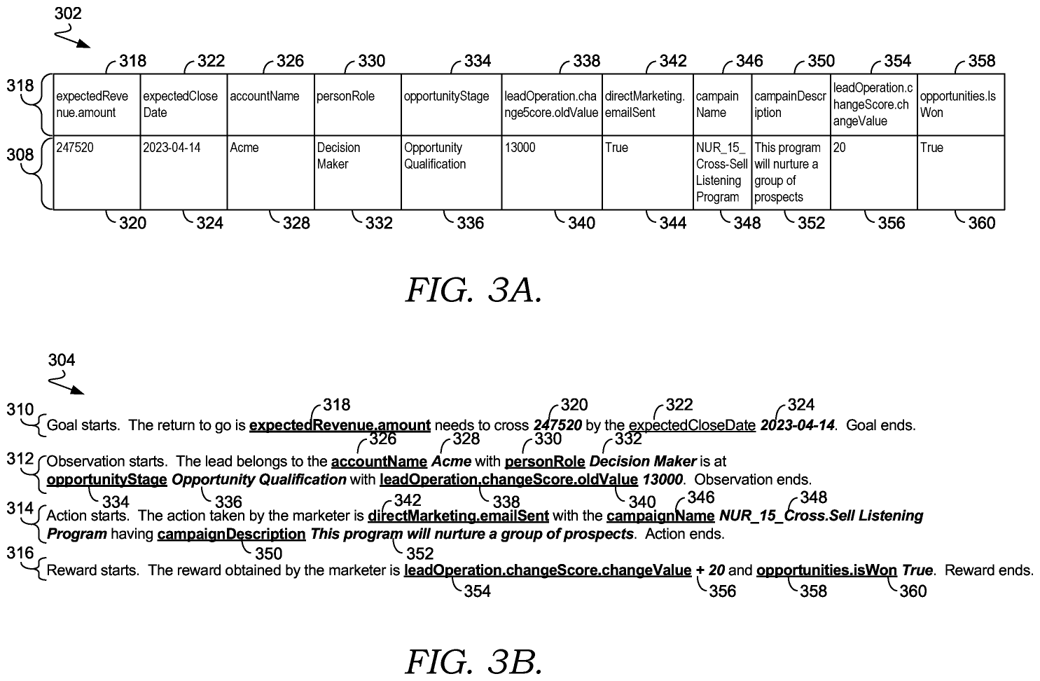

FIGS. 3A and 3B provide an example in which a verbalized step 304 is generated from tabular data 302. In particular, FIG. 3A shows tabular data 302, which includes columns corresponding to various features with column headings 306 that provide column names for the features. The tabular data 302 also includes a record (i.e., row) 308 providing values corresponding to the features of the columns. In this example, the record 308 corresponds to a step of trajectory. While only a single record 308 is shown in FIG. 3A for simplicity purposes, the tabular data 302 could include multiple records with each record corresponding with a step in a trajectory. As such, a verbalized step (similar to the verbalized step 304) would be generated for each record in the tabular data 302.

FIG. 3B shows a verbalized step 304 generated based on the tabular data 302 including the column names 306 and the record 308. As shown in FIG. 3B, the verbalized step 304 includes a goal verbalization 310, a state verbalization 312, an action verbalization 314, and a reward verbalization 316. Although not labeled in FIG. 3B, each of the goal verbalization 310, state verbalization 312, action verbalization 314, and reward verbalization 316 comprise introductory and concluding sentences to help identify the beginning and end of each portion of the verbalized step 304 (i.e., “Goal starts.”; “Goal end.”; “Observation starts.”; “Observation end.”; “Action starts.”; “Action ends.”; “Reward starts.”; and Reward ends.”).

In between the introductory and concluding sentences for each of the goal verbalization 310, state verbalization 312, action verbalization 314, and reward verbalization 316 are data natural language sentences generated from the tabular data 302 using the column (i.e., feature) names 306 and values for the features from the record 308. In accordance with some embodiments, a template is used to map the column names 306 and the values from the record 308 to each of the verbalizations 310, 312, 314, 316. For instance, a template could be used for each of the verbalizations 310, 312, 314, 316 that includes one or more natural language sentences with placeholders. The verbalizations 310, 312, 314, 316 are then generated by mapping the column names 306 and the values from the record 308 to particular placeholders in the natural language sentences of the templates. It should be noted that a template approach is provided by way of example, and other approaches for generating natural language sentences from the tabular data 302 to generate the verbalizations 310, 312, 314, 316 could be used within the scope of the technology described herein.

In FIG. 3B, portions of the verbalizations 310, 312, 314, 316 that correspond to the column names 306 are shown as underlined and the portions that correspond to the values from the record 308 are shown as italicized. In particular, the goal verbalization 310 includes a natural language sentence that has been populated with the column name 318 with corresponding value 320 and the column name 322 with the corresponding value 324. The state verbalization 312 includes a natural language sentence that has been populated with the column name 326 with corresponding value 328, the column name 330 with corresponding value 332, the column name 334 with corresponding value 336, and the column name 338 with corresponding value 340. The action verbalization 314 includes a natural language sentence that has been populated with the column name 342, the column name 346 with corresponding value 348, and the column name 350 with corresponding value 352. The reward verbalization 316 includes a natural language sentence that has been populated with the column name 354 with corresponding value 356, and the column name 358 with corresponding value 360.

While FIGS. 3A and 3B provide an example of verbalized data generated for a single step of a trajectory (i.e., a single record/row in tabular data), in operation, verbalized data (similar to the verbalized step 304) would be generated for each step of the trajectory (i.e., each record/row in tabular data). As such, the verbalized data for the trajectory would include an ordered sequence of verbalized steps (similar to the verbalized step 304) corresponding to the goal, state, action, and reward data from the ordered sequence of steps for the trajectory. Verbalized data could similarly be generated for each trajectory in the sequential data available to the system.

With reference again to FIG. 1, the model training component 112 of the recommendation system 104 trains a generative model using the verbalized structured data generated by the verbalization component 110. In some aspects, the model training component 112 uses the verbalized structured data to fine-tune a pre-trained model, such as a pre-trained language model. A language model includes a set of statistical or probabilistic functions that performs Natural Language Processing (NLP) in order to understand, learn, and/or generate human natural language content. For example, a language model can be a tool that determines the probability of a given sequence of words occurring in a sentence (e.g., via NSP or MLM) or natural language sequence. Simply put, it can be a model that is trained to predict the next word in a sentence. A language model is called an LLM when it is trained on enormous amount of data. Some examples of LLMs are GOOGLE's BERT and OpenAI's GPT-2 and GPT-3. These models have capabilities ranging from writing a simple essay to generating complex computer codes-all with limited to no supervision. Accordingly, an LLM can comprise a deep neural network that is very large (billions to hundreds of billions of parameters) and understands, processes, and produces human natural language by being trained on massive amounts of text. These models can predict future words in a sentence letting them generate sentences similar to how humans talk and write.

In accordance with some aspect, the generative model comprises a neural network. As used herein, a neural network comprises at least three operational layers, although a neural network may include many more than three layers (i.e., a deep neural network). The three layers can include an input layer, a hidden layer, and an output layer. Each layer comprises neurons. Different types of layers and networks connect neurons in different ways. Neurons have weights, an activation function that defines the output of the neuron given an input (including the weights), and an output. The weights are the adjustable parameters that cause a network to produce a correct output.

The model training component 112 trains the neural network of the generative model to fit the training data. In this case, the training data comprises verbalized sequential data for one or more trajectories, in which each trajectory is a training sample. Given this training data, model training component 112 trains the generative model to generate recommendations given certain prompts. In particular, the generative model is trained to generate recommendations with particular actions based on inputs that provide state information. During training, weights associated with each neuron can be updated. Originally, the generative model can comprise random weight values or pre-trained weight values that are adjusted during training. In one aspect, the generative model is trained using backpropagation. The backpropagation process comprises a forward pass, a loss function, a backward pass, and a weight update. This process is repeated using the training data. The goal is to update the weights of each neuron (or other model component) to cause the generative model to produce an output that recommends actions given inputs with state information (e.g., a single step or multiple steps in a sequential decision making process). Once trained, the weight associated with a given neuron can remain fixed. The other data passing between neurons can change in response to a given input (e.g., an input item listing). Retraining the network with additional training data can update one or more weights in one or more neurons.

In some configurations, training a generative model with verbalized sequential data for a given step can include providing, to the generative model, an input that includes the state verbalization for the step (and, in some cases, the goal verbalization for the step). Given the input, the generative model generates an output. The generative model is then updated (e.g., using backpropagation) based on the output and the action verbalization for the step (and, in some cases, the reward verbalization for the step). This process can be repeated for each step of the trajectory, and for each trajectory in the training data.

Once the generative model has been trained on the verbalized sequential data by the model training component, the recommendation component 114 of the recommendation system 104 employs the trained generative model to generate recommendations. Given an input prompt comprising state information for a decision making process, the trained generative model generates an output with a recommended action. In some cases, the prompt can be a simple input with limited information, such as information describing a current state of a decision making process. In other cases, the prompt can be a complex information with state information describing multiple steps of the trajectory of a decision making process.

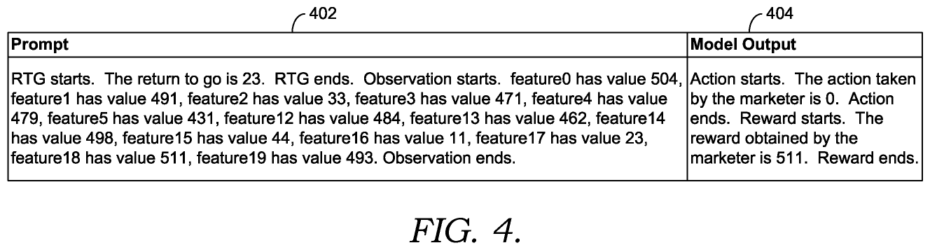

FIG. 4 provides an example of input and output for a generative model in accordance with some aspects of the technology described herein. In particular, FIG. 4 shows a prompt 402 provided as input to the generative model and an output 404 generated by the generative model. This could be in the context of training the generative model (e.g., by the model training component 112 of FIG. 1) or using a trained generative model to generate recommendations (e.g., by the recommendation component 114 of FIG. 1). While the prompt 402 shown in FIG. 4 is relatively small and includes verbalized data for a single step, it should be understood that in operation, a longer prompt with more data for a single step or data for multiple steps in a trajectory could be provided as input to the generative model.

Turning again to FIG. 1, the recommendation system 104 further includes a user interface component 116 that provides one or more user interfaces for interacting with the image processing system 104. The user interface component 116 provides one or more user interfaces to a user device, such as the user device 102. In some instances, the user interfaces can be presented on the user device 102 via the application 108, which can be a web browser or a dedicated application for interacting with the image processing system 104. For instance, the user interface component 116 can provide user interfaces for, among other things, interacting with the recommendation system 104 to facilitate the generation of verbalized sequential data and/or to train a generative model for generating recommendations using the verbalized sequential data. In some aspects, once a generative model has been trained, the user interface component 116 provides user interfaces for submitting prompts that are provided as input to the trained generative model and providing recommendations generated by the trained generative model give the input prompts.

### Example Methods for Generative Recommendations Leveraging Verbalized Sequential Data

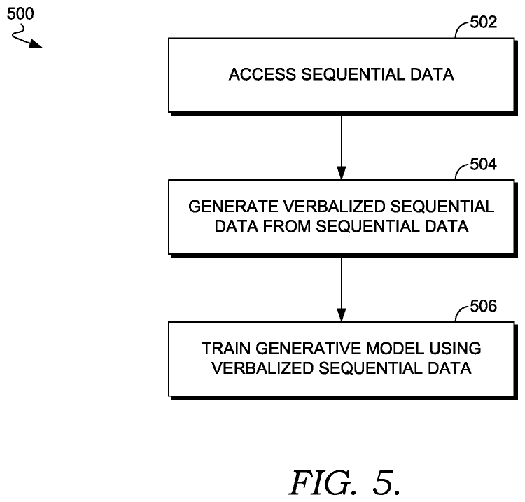

With reference now to FIG. 5, a flow diagram is provided that illustrates a method 500 for training a generative model using verbalized sequential data. The method 500 can be performed, for instance, by the recommendation system 110 of FIG. 1. Each block of the method 500 and any other methods described herein comprises a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

As shown at block 502, sequential data is accessed. The sequential data generally includes data for one or more trajectories, each trajectory having an ordered sequence of steps. The data for each step comprises a tuple. Each tuple comprises at least data regarding a state at the step and an action taken at the step. In some instance, each tuple can further include a goal and a reward for the step. In some configurations, the sequential data comprises tabular data in which each row/record of the tabular data comprises a step in a trajectory.

Verbalized sequential data is generated from the sequential data, as shown at block 504. This involves converting the sequential data from its original form to a verbalized form comprising natural language sentences. In some configurations, one or more templates are used to map data from the sequential data to natural language sentences, although other approaches can be used to generate the natural language sentences.

As shown at block 506, a generative model is trained using the verbalized sequential data to provide a trained generative model that generates recommended actions given a current state. The generative model can be trained by iteratively providing the generative model verbalized sequential data for a step, generating an output, and updating the generative model based on the output (e.g., via backpropagation). In some configurations, a state verbalization from the verbalized sequential data for the step (in some instances, with a goal verbalization) is provided as input to the generative model, which generates an output. The output is used in conjunction with an action verbalization from the verbalized sequential data for the step (in some instances, with a reward verbalization) to update the generative model.

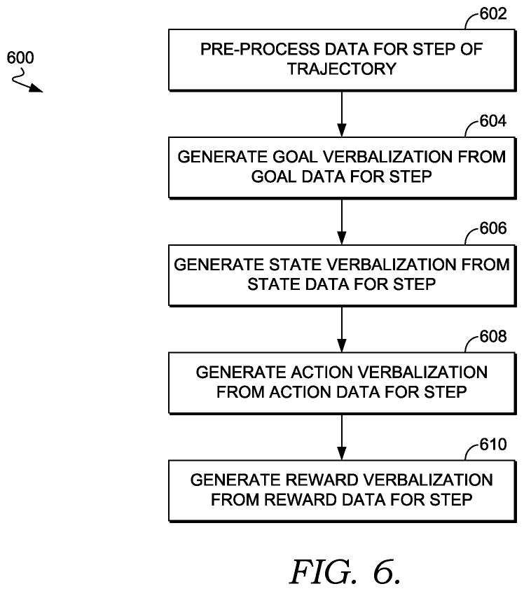

Turning next to FIG. 6, a flow diagram is provided that illustrates a method 600 for generating verbalized sequential data for a step of a trajectory. The method 600 can be performed, for instance, by the verbalization component 110 of FIG. 1. The method 600 could be performed for each step of the trajectory to provide verbalized sequential data for the trajectory.

As shown at block 602, sequential data for a step of a trajectory is pre-processed. This could include a variety of operations. For instance, in some instances, a goal is determined for the step. In some aspects, the goal is a return_to_go, which comprises a cumulative reward remaining for the trajectory at that step. Another pre-processing operation could comprise converting any continuous values in the data for the step to discrete values.

In the present example embodiment, the sequential data for the step is a tuple that comprises goal data, state data, action data, and reward data. It should be understood that in other embodiments, not all types of data are employed. For instance, in some embodiments, only state data and action data is employed. As shown at block 604, a goal verbalization is generated by creating one or more natural language sentences from the goal data for the step. As shown at block 606, a state verbalization is generated by creating one or more natural language sentences from the state data for the step. As shown at block 608, a action verbalization is generated by creating one or more natural language sentences from the action data for the step. As shown at block 610, a reward verbalization is generated by creating one or more natural language sentences from the reward data for the step. In some configurations, in addition to data natural language sentences with the data for the step, each verbalization includes an introductory and concluding sentence (e.g., “Action starts”; and “Action end”) to delineate the verbalizations to facilitate training a generative model on the verbalized data.

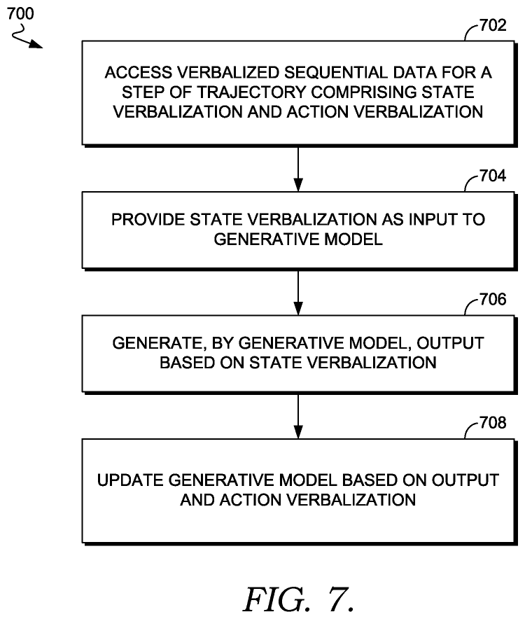

With reference now to FIG. 7, a flow diagram is provided that illustrates a method 700 for training a generative model on verbalized sequential data for a step of a trajectory. The method 700 can be performed, for instance, by the model training component 112 of FIG. 1. The method 700 can be performed for each step of the trajectory to train the generative model. Additionally, the generative model could be trained on sequential data for multiple trajectories.

As shown at block 702, verbalized sequential data for a step of a trajectory is accessed. The verbalized sequential data includes a state verbalization generated from state data for the step and an action verbalization generated from action data for the step. In some configurations, the verbalized sequential data can further include a goal verbalization generated from goal data for the step and/or a reward verbalization generated from reward data for the step.

The state verbalization is provided as input to the generative model, as shown at block 704. In configurations in which the verbalized sequential data also includes a goal verbalization, the input to the generative model can further include the goal verbalization. As shown at block 706, the generative model generates an output based on the state verbalization (and goal verbalization in some configurations). As shown at block 708, the generative model is updated (e.g., via backpropagation based on the output from the generative model and the action verbalization (and the reward verbalization in some configurations).

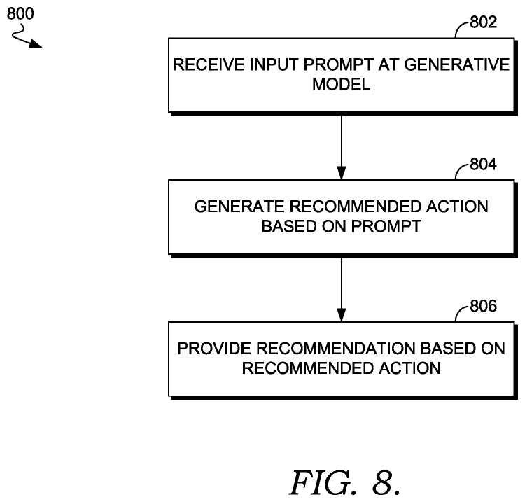

Turning to FIG. 8, a flow diagram is provided that illustrates a method 800 for employing a trained generative model to provide a recommendation. The method 800 can be performed, for instance, by the recommendation component 114 of FIG. 1.

As shown at block 802, an input prompt is received. The input prompt can be in any of a number of different forms. For instance, the input can be a natural language input with simple information or the input can be more complex and include structured information (e.g., tabular data). The input could include information regarding a current state of a decision-making process or could include information for multiple steps in a current trajectory of a decision-making process.

The prompt is provided as input to a trained generative model (e.g., trained using verbalized sequential data by the method 700 of FIG. 7), which generates a recommended action based on the prompt, as shown at block 804. A recommendation is provided for presentation based on the recommended action, as shown at block 806. The recommendation provided for presentation can comprise the recommended action as generated by the generative model or another form that is generated from the recommended action output by the generative model.

### Experimental Results

Experiments were performed to compare the performance of the technology described herein against a prior art RL approach. In these experiments, trajectories generated using the interest evolution environment of the RecSim platform were utilized. To incorporate marketing data into this environment, 250,000 trajectories were collected, with each trajectory including approximately 120 (state, action, reward) tuples derived from real-world marketing scenarios. This approach allows for effectively testing with relevant marketing data integrated into the RecSim environment. These trajectories were verbalized using the technology described herein to provide natural language sentences that were then fed into a pre-trained GPT-2 model (124 million parameters). The window size for this model was 5 steps, the block size was 1024, the learning rate was 0.0001, the batch size was 8, and the maximum number of iterations in one epoch was 100,000. The model was trained on two A100 GPUs, and one epoch roughly took around 4 hours to finish.

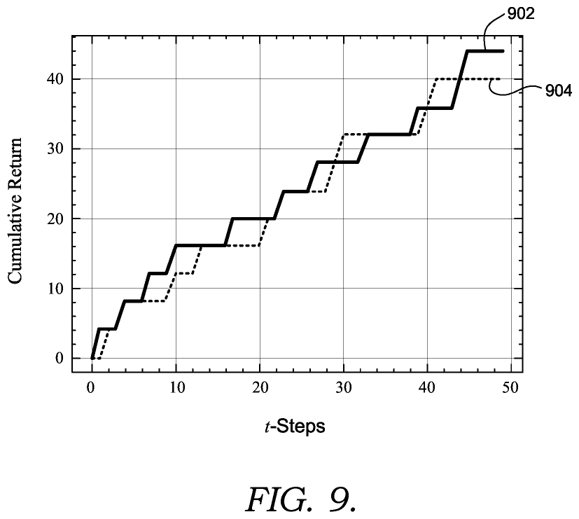

FIG. 9 provides a comparison of the performance of the technology described herein 902 against a current state-of-the-art RL approach 904 (Full Slate Q-Learning). As can be seen from FIG. 9, the technology described herein outperforms the current state-of-the-art RL approach.

### Exemplary Operating Environment

Having described implementations of the present disclosure, an exemplary operating environment in which embodiments of the present technology can be implemented is described below in order to provide a general context for various aspects of the present disclosure. Referring initially to FIG. 10 in particular, an exemplary operating environment for implementing embodiments of the present technology is shown and designated generally as computing device 1000. Computing device 1000 is but one example of a suitable computing environment and is not intended to suggest any limitation as to the scope of use or functionality of the technology. Neither should the computing device 1000 be interpreted as having any dependency or requirement relating to any one or combination of components illustrated.

The technology can be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The technology can be practiced in a variety of system configurations, including hand-held devices, consumer electronics, general-purpose computers, more specialty computing devices, etc. The technology can also be practiced in distributed computing environments where tasks are performed by remote-processing devices that are linked through a communications network.

With reference to FIG. 10, computing device 1000 includes bus 1010 that directly or indirectly couples the following devices: memory 1012, one or more processors 1014, one or more presentation components 1016, input/output (I/O) ports 1018, input/output components 1020, and illustrative power supply 1022. Bus 1010 represents what can be one or more busses (such as an address bus, data bus, or combination thereof). Although the various blocks of FIG. 10 are shown with lines for the sake of clarity, in reality, delineating various components is not so clear, and metaphorically, the lines would more accurately be grey and fuzzy. For example, one can consider a presentation component such as a display device to be an I/O component. Also, processors have memory. The inventors recognize that such is the nature of the art, and reiterate that the diagram of FIG. 10 is merely illustrative of an exemplary computing device that can be used in connection with one or more embodiments of the present technology. Distinction is not made between such categories as “workstation,” “server,” “laptop,” “hand-held device,” etc., as all are contemplated within the scope of FIG. 10 and reference to “computing device.”

Computing device 1000 typically includes a variety of computer-readable media. Computer-readable media can be any available media that can be accessed by computing device 1000 and includes both volatile and nonvolatile media, removable and non-removable media. By way of example, and not limitation, computer-readable media can comprise computer storage media and communication media.

Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 1000. Computer storage media does not comprise signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1012 includes computer storage media in the form of volatile and/or nonvolatile memory. The memory can be removable, non-removable, or a combination thereof. Exemplary hardware devices include solid-state memory, hard drives, optical-disc drives, etc. Computing device 1000 includes one or more processors that read data from various entities such as memory 1012 or I/O components 1020. Presentation component(s) 1016 present data indications to a user or other device. Exemplary presentation components include a display device, speaker, printing component, vibrating component, etc.

I/O ports 1018 allow computing device 1000 to be logically coupled to other devices including I/O components 1020, some of which can be built in. Illustrative components include a microphone, joystick, game pad, satellite dish, scanner, printer, wireless device, etc. The I/O components 1020 can provide a natural user interface (NUI) that processes air gestures, voice, or other physiological inputs generated by a user. In some instance, inputs can be transmitted to an appropriate network element for further processing. A NUI can implement any combination of speech recognition, touch and stylus recognition, facial recognition, biometric recognition, gesture recognition both on screen and adjacent to the screen, air gestures, head and eye-tracking, and touch recognition associated with displays on the computing device 1000. The computing device 1000 can be equipped with depth cameras, such as, stereoscopic camera systems, infrared camera systems, RGB camera systems, and combinations of these for gesture detection and recognition. Additionally, the computing device 1000 can be equipped with accelerometers or gyroscopes that enable detection of motion.

The present technology has been described in relation to particular embodiments, which are intended in all respects to be illustrative rather than restrictive. Alternative embodiments will become apparent to those of ordinary skill in the art to which the present technology pertains without departing from its scope.

Having identified various components utilized herein, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions) can be used in addition to or instead of those shown.

Embodiments described herein can be combined with one or more of the specifically described alternatives. In particular, an embodiment that is claimed can contain a reference, in the alternative, to more than one other embodiment. The embodiment that is claimed can specify a further limitation of the subject matter claimed.

The subject matter of embodiments of the technology is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further, the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technology are described with reference to a distributed computing environment; however, the distributed computing environment depicted herein is merely exemplary. Components can be configured for performing novel embodiments of embodiments, where the term “configured for” can refer to “programmed to” perform particular tasks or implement particular abstract data types using code. Further, while embodiments of the present technology can generally refer to the technical solution environment and the schematics described herein, it is understood that the techniques described can be extended to other implementation contexts.

From the foregoing, it will be seen that this technology is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. One or more computer storage media storing computer-useable instructions that, when used by a computing device, cause the computing device to perform operations, the operations comprising:
accessing, from the one or more computer storage media, sequential data for a trajectory comprising a plurality of steps, the sequential data comprising a tuple for each step of the trajectory;
generating verbalized sequential data from the sequential data, the verbalized sequential data for each step of the trajectory comprising one or more natural language sentences generated from the tuple for the step; and
training a generative model on the verbalized sequential data to provide a trained generative model that generates a recommended action given a prompt specifying a current state.

2. The one or more computer storage media of claim 1, wherein the sequential data comprises tabular data in which each row of the tabular data comprises a step from the plurality of steps for the trajectory.

3. The one or more computer storage media of claim 1, wherein generating the verbalized sequential data for a first step of the plurality of steps comprises:
employing a template to map data from a first tuple for the first step into one or more natural language sentences for the first step.

4. The one or more computer storage media of claim 3, wherein generating the verbalized sequential data for the first step of the plurality of steps further comprises:
determining a cumulative reward for the trajectory at the first step; and
appending the cumulative reward to the first tuple.

5. The one or more computer storage media of claim 3, wherein generating the verbalized sequential data for the first step of the plurality of steps further comprises:
converting a first continuous value of the first tuple to a discrete value.

6. The one or more computer storage media of claim 1, wherein a first tuple for a first step of the plurality of steps comprises state data and action data, and wherein generating the verbalized sequential data for the first step of the plurality of steps comprises:
generating a state verbalization based on the state data; and
generative an action verbalization based on the action data.

7. The one or more computer storage media of claim 6, wherein the state verbalization comprises a first introductory natural language sentence, a first data natural language sentence based on the state data, and a first concluding natural language sentence; and wherein the action verbalization comprises a second introductory natural language sentence, a second data natural language sentence based on the action data, and a second concluding natural language sentence.

8. The one or more computer storage media of claim 6, wherein training the generative model on the verbalized sequential data comprises:
providing, to the generative model, an input comprising the state verbalization;
generating, by the generative model, an output based on the state verbalization; and
updating the generative model based on the output and the action verbalization.

9. The one or more computer storage media of claim 8, wherein the verbalized sequential data for the first step of the plurality of steps further comprises a goal verbalization and a reward verbalization; wherein the input further comprises the goal verbalization; and wherein the generative model is updated based on the output, the action verbalization, and the reward verbalization.

10. A computer-implemented method comprising:
generating, by a verbalization component, verbalized sequential data based on sequential data for one or more trajectories;
training, by a model training component, a generative model using the verbalized sequential data to provide a trained generative model;
generating, by the trained generative model using an input prompt, a recommended action; and
providing, by a user interface component, a recommendation for presentation based on the recommended action.

11. The computer-implemented method of claim 10, wherein generating the verbalized sequential data based on the sequential data comprises employing one or more templates to map one or more portions of the sequential data to one or more natural language sentences.

12. The computer-implemented method of claim 10, wherein generating the verbalized sequential data based on the sequential data comprises determining goal data for each step of a plurality of steps for a first trajectory from the one or more trajectories.

13. The computer-implemented method of claim 10, wherein generating the verbalized sequential data based on the sequential data comprises converting one or more continuous values in the sequential data to one or more discrete values.

14. The computer-implemented method of claim 10, wherein generating the verbalized sequential data for a first step of a first trajectory from the one or more trajectories comprises:
accessing state data for the first step of the first trajectory;
generating a state verbalization comprising a first set of one or more natural language sentences with the state data;
accessing action data for the first step of the first trajectory; and
generating an action verbalization comprising a second set of one or more natural language sentences with the action data.

15. The computer-implemented method of claim 14, wherein the state verbalization includes a first introductory sentence identifying a beginning of the state verbalization and a first concluding sentence identifying an ending of the state verbalization; and wherein the action verbalization includes a second introductory sentence identifying a beginning of the action verbalization and a second concluding sentence identifying an ending of the action verbalization

16. The computer-implemented method of claim 14, wherein training the generative model using the verbalized sequential data comprises:
providing, to the generative model, an input comprising the state verbalization;
generating, by the generative model, an output based on the input; and
updating the generative model using the output and the action verbalization.

17. The computer-implemented method of claim 14, wherein generating the verbalized sequential data for the first step of the first trajectory from the one or more trajectories further comprises:
accessing goal data for the first step of the first trajectory;
generating a goal verbalization comprising a third set of one or more natural language sentences with the goal data;
accessing reward data for the first step of the first trajectory; and
generating a reward verbalization comprising a fourth set of one or more natural language sentences with the reward data.

18. The computer-implemented method of claim 17, wherein training the generative model using the verbalized sequential data comprises:
providing, to the generative model, an input comprising the state verbalization and the goal verbalization;
generating, by the generative model, an output based on the input; and
updating the generative model using the output, the action verbalization, and the reward verbalization.

19. A computer system comprising:
one or more processors; and
one or more computer storage media storing computer-useable instructions that, when used by the one or more processors, causes the one or more processors to perform operations comprising:
receiving, by a user interface component, an input prompt;
providing, by a recommendation component, the input prompt to a generative model trained on verbalized sequential data comprising one or more natural language sentences generated from values in sequential data;
generating, by the generative model using the input prompt, a recommended action; and
providing, by the user interface component, a recommendation for presentation based on the recommended action.

20. The computer system of claim 19, wherein the verbalized sequential data used to train the generative model comprises a state verbalization and an action verbalization for each step of a plurality of steps for a trajectory in the sequential data.
